(19) United States
(12) Patent Application Publication
(10) Pub. No.: US 2026/0346784 A1
(43) Pub. Date: Nov. 5, 2026

(54) HIGH-VOLTAGE ISOLATION FAILURE NOTIFICATION SYSTEM AND METHOD

(71) Applicant: Traton AB, Södertälje (SE)

(72) Inventor: Bhupendra Jadhav, Chicago, IL (US)

(73) Assignee: Traton AB, Södertälje (SE)

(21) Appl. No.: 19/197,362

(22) Filed: May 2, 2025

(51) Int. Cl. B60Q 1/52; B60L 3/00; B60Q 5/00

(52) U.S. Cl. CPC B60Q 1/52; B60L 3/0069; B60Q 5/005

(57) ABSTRACT

A high-voltage isolation failure notification system is provided for providing notification that is observable outside of a vehicle of a high-voltage isolation fault being detected. The high-voltage isolation failure notification system may include a monitoring component, fault detection component, notification component, and audiovisual alert. A method for providing notification that is observable outside of a vehicle of a high-voltage isolation fault being detected using the high-voltage isolation failure notification system is also provided.

### FIELD OF THE INVENTION

The present disclosure relates to a high-voltage isolation failure notification system. More particularly, the disclosure relates to providing notification that is observable outside of a vehicle of a high-voltage isolation fault being detected.

### BACKGROUND

The increasing demand for electric vehicles (EVs) and hybrid electric vehicles (HEVs) is driven by growing concerns over environmental pollution and the depletion of fossil fuels. These vehicles offer a cleaner and more sustainable mode of transportation, but they also present unique challenges in terms of safety, particularly with regards to the high-voltage systems they employ. Unlike traditional internal combustion engine vehicles, EVs and HEVs utilize high-voltage batteries and electrical components that can pose significant risks if not properly managed. These risks include electric shock to passengers and first responders in the event of an accident, as well as potential fire hazards due to short circuits or damage to high-voltage cables.

To mitigate these risks, robust safety systems are essential in EVs and HEVs capable of continuously monitoring the integrity of the high-voltage system and effectively alerting a user if a high-voltage isolation fault has occurred. The current notification system for high-voltage faults in electric vehicles has a significant limitation—it only alerts the user when they are already inside the vehicle, such as via an in-cab malfunction indicator lamp (MIL), human-machine interface (HMI) message, or generation of a diagnostic trouble code (DTC). If a fault occurs while the vehicle is unoccupied, the driver or a technician might approach the vehicle unaware of the danger, potentially leading to an electric shock. This delay in notification inherent to the prior state of the art poses a safety risk to anyone interacting with the vehicle, including service personnel and passersby.

Therefore, a need exists to solve the deficiencies present in the prior art. What is needed is a system to clearly notify a user that a high-voltage isolation fault has occurred that is observable from outside of a vehicle. What is needed is a system to mitigate risk of electric shock by notifying of a detected high-voltage isolation failure prior to a user making contact with the vehicle. What is needed is a system and method to provide an audiovisual alert that is observable from outside of the vehicle upon detection of a high-voltage isolation fault.

### SUMMARY

An aspect of the disclosure advantageously provides a system to clearly notify a user that a high-voltage isolation fault has occurred that is observable from outside of a vehicle. An aspect of the disclosure advantageously provides a system to mitigate risk of electric shock by notifying of a detected high-voltage isolation failure prior to a user making contact with the vehicle. An aspect of the disclosure advantageously provides a system and method to provide an audiovisual alert that is observable from outside of the vehicle upon detection of a high-voltage isolation fault.

Accordingly, the disclosure may feature a high-voltage isolation failure notification system for a vehicle including a monitoring component, a fault detection component, and a notification component. The monitoring component may monitor a high-voltage system and a chassis for a voltage condition. The fault detection component may determine whether the voltage condition between the high-voltage system and the chassis is indicative of a high-voltage isolation fault. The notification component may, upon detection of a high-voltage isolation fault, operatively engage an energy management module to cause an audiovisual alert to be produced that is observable from outside of the vehicle to warn of precautions required to mitigate risk of receiving an electric shock.

In another aspect, at least part of the audiovisual alert may be produced as a pseudorandom display of audiovisual signals to bring attention to detection of the high-voltage isolation fault.

In another aspect, at least part of the audiovisual alert may be produced as a coded pattern of audiovisual signals that indicates that the high-voltage isolation fault is detected.

In another aspect, the notification component may engage the energy management module to command a body management controller to operate vehicle equipment to produce the audiovisual alert such to bring attention to the vehicle.

In another aspect, the audiovisual alert includes a visual alert provided by a light of the vehicle capable of being observed from outside of the vehicle, the light being operated by the body management controller.

In another aspect, the light may include headlamps and blinkers being operated by the body management controller.

In another aspect, the audiovisual alert includes an audio alert capable of being observed from outside of the vehicle that is provided by a sound emitting component operated by the body management controller.

In another aspect, the sound emitting component may include a horn, and wherein producing the audio alert comprises operating the horn in short blips.

Accordingly, the disclosure may feature a system for providing notification of detection of a high-voltage isolation failure for a vehicle including a monitoring component, a fault detection component, and a notification component. The monitoring component may monitor a high-voltage system and a chassis for a voltage condition. The fault detection component may determine whether the voltage condition between the high-voltage system and the chassis is indicative of a high-voltage isolation fault. The notification component may, upon detection of a high-voltage isolation fault, operatively engage an energy management module to command a body management controller to operate vehicle equipment to produce an audiovisual alert to warn of a risk of receiving an electric shock. The vehicle equipment may be capable of being observed outside of the vehicle and include a light and a sound emitting component. The audiovisual alert may include a visual alert provided by the light and an audio alert provided by the sound emitting component.

In another aspect, at least part of the audiovisual alert may be produced as a pseudorandom display of the visual alert and the audio alert to bring the attention to the detection of the high-voltage isolation fault.

In another aspect, at least part of the audiovisual alert may be produced as a coded pattern of the visual alert and the audio alert that indicates that the high-voltage isolation fault is detected.

In another aspect, the light is emitted by headlamps and blinkers and the audio alert is emitted by a horn.

Accordingly, the disclosure may feature a method for providing a notification capable of being observed from outside of a vehicle of a high-voltage isolation failure for the vehicle. The method may include monitoring a high-voltage system and a chassis for a voltage condition. The method may additionally include determining whether the voltage condition between the high-voltage system and the chassis is indicative of a high-voltage isolation fault. The method may also include, upon detection of a high-voltage isolation fault, engaging an energy management module to notify of a risk of receiving an electric shock. Furthermore, the method may include operating vehicle equipment via a body management controller to produce an audiovisual alert that is observable from outside of the vehicle. The audiovisual alert may include a visual alert provided by a light of the vehicle and an audio alert provided by a sound emitting component of the vehicle.

In another aspect of the method, operating the vehicle equipment may further include producing at least part of the audiovisual alert as a pseudorandom display of the visual alert and the audio alert to bring the attention to the detection of the high-voltage isolation fault.

In another aspect of the method, the light may include headlamps and blinkers, and the sound emitting component may include a horn.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative high-voltage isolation failure notification system, according to an embodiment of this disclosure.

FIG. 2 is a side elevation view of an illustrative audiovisual alert being displayed, according to an embodiment of this disclosure.

FIG. 3 is a front elevation view of an illustrative audiovisual alert being displayed, according to an embodiment of this disclosure.

FIG. 4 is a graph view of an illustrative audiovisual alert provided as a coded pattern, according to an embodiment of this disclosure.

FIG. 5 is a flowchart view of an illustrative operation of providing notification of a detected high-voltage isolation fault, according to an embodiment of this disclosure.

### DETAILED DESCRIPTION

The following disclosure is provided to describe various embodiments of a high-voltage isolation failure notification system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term high-voltage system, as it is used throughout this disclosure, is defined as a system within a vehicle that operates above 12 volts, and typically includes the battery pack, drive motors, and related components. The term chassis, as it is used throughout this disclosure, is defined as the vehicle's metal frame that serves as a common return path for the electrical current.

The term energy management module, as it is used throughout this disclosure, is defined as a system responsible for intelligently distributing and controlling the flow of energy throughout the vehicle. The term body management controller, as it is used throughout this disclosure, is defined as a computer and/or controller that monitors and controls various electronic accessories throughout the vehicle's body and other non-powertrain related vehicle equipment. The term vehicle equipment, as it is used throughout this disclosure, is defined as components and other devices provided by a vehicle, for example, lights, headlamps, blinkers, sound emitting components, a horn, and other equipment that would be appreciated by those of skill in the art after having the benefit of this disclosure.

The term pseudorandom display, as it is used throughout this disclosure, is defined as an array of outputs that are essentially random, but may be generated using an algorithm or other underlying structure. The term coded pattern, as it is used throughout this disclosure, is defined as a predictable sequence of outputs that, when recognized, indicate a decipherable message.

Various aspects of the present disclosure will now be described in detail, without limitation. In the following disclosure, a high-voltage isolation failure notification system will be discussed. Those of skill in the art will appreciate alternative labeling of the high-voltage isolation failure notification system as a high-voltage isolation failure warning system, externally observable notification system for high-voltage isolation faults, vehicle warning system, the invention, or other similar names. Similarly, those of skill in the art will appreciate alternative labeling of the high-voltage isolation failure notification system as a method of providing externally observable warnings of high-voltage isolation faults, method of producing notifications that are observable outside of a vehicle regarding failure of high-voltage isolation, method for informing a user of a vehicle condition without requiring contact with the vehicle, method, operation, the invention, or other similar names. Skilled readers should not view the inclusion of any alternative labels as limiting in any way.

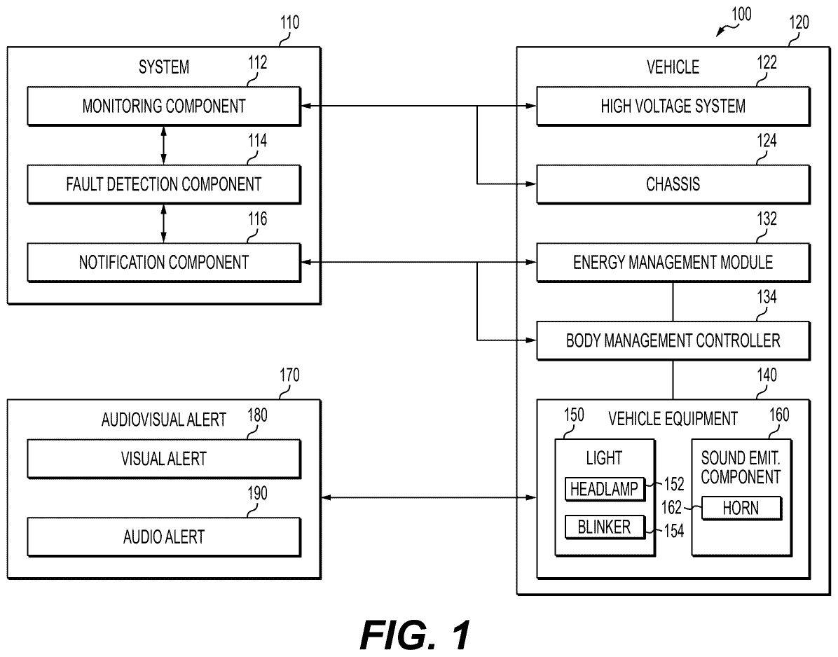

Referring now to FIGS. 1-5, the high-voltage isolation failure notification system will now be discussed in more detail. The high-voltage isolation failure notification system may include a monitoring component, fault detection component, notification component, audiovisual alert, and additional components that will be discussed in greater detail below. The high-voltage isolation failure notification system may operate one or more of these components interactively with other components for providing notification that is observable outside of a vehicle of a high-voltage isolation fault being detected.

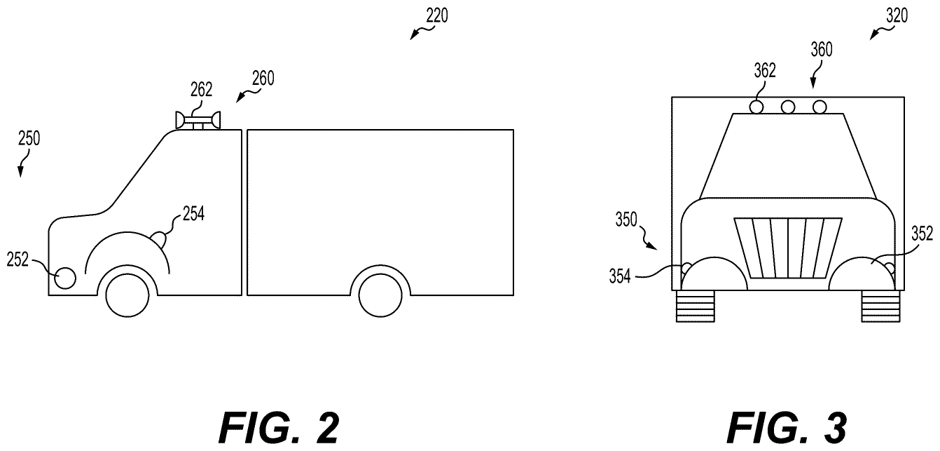

As provided in the example block diagram 100 of FIG. 1 and views of FIGS. 2-3, an illustrative system 110 may include a monitoring component 112, fault detection component 114, and notification component 116. Each of these components will be discussed in greater detail below. The system may interact with a vehicle 120, 220, 320. The vehicle 120, 220, 320 may include a high-voltage system 122 and a chassis 124, about which voltage resistance may be measured to determine a voltage characteristic. The vehicle 120, 220, 320 may additionally include an energy management module 132 and body management controller 134. These components will be discussed in greater detail below. The vehicle 120, 220, 320 may additionally include vehicle equipment 140. Example vehicle equipment may include a light 150, 250, 350, for example a headlamp 152, 252, 352 and/or blinker 154, 254, 354, and sound emitting components 160, 260, 360, for example a horn 162, 262, 362. The vehicle 120, 220, 320, including the vehicle equipment 140, may provide an audiovisual alert 170. The audiovisual alert 170 may include a visual alert 180 and/or an audio alert 190.

The monitoring component will now be discussed in greater detail. FIG. 1 highlights examples of the monitoring component, which may also be shown in other figures. The monitoring component 112 may monitor voltage levels about various locations of a vehicle 120, 220, 320, potentials between different voltage systems, and resistances between the voltage systems to determine a voltage condition. For example, the monitoring component 112 may use Isolation Monitoring Devices (IMDs), which may monitor a resistance between the high-voltage system 122 and the vehicle chassis 124. If this resistance drops below a safe threshold value, a fault may have occurred.

As will be appreciated by those of skill in the art, a monitoring component 112 that uses an IMD may operate via DC injection, AC injection, or otherwise. In configurations using DC injection, a small DC voltage may be applied, and leakage current may be measured. In configurations using AC injection, a low-frequency AC signal may be used for improved sensitivity. In additional configurations, sensors may monitor for unexpected voltage differences between system parts such as the high-voltage system 122 and the chassis 124, indicating a potential issue. Additionally, the vehicle's onboard diagnostics system may monitor for faults, storing Diagnostic Trouble Codes (DTCs) in the event of an anomalous observation. In some embodiments, multiple monitoring configurations may be operated substantially simultaneously to improve efficacy and provide redundancy.

The fault detection component will now be discussed in greater detail. FIG. 1 highlights examples of the fault detection component, which may also be shown in other figures. As will be appreciated by those of skill in the art, the fault detection component may operate in a manner that is compatible with configurations of the monitoring component 112, without limitation. For example, where the monitoring component 112 operates via an Isolation Monitoring Device (IMD), the fault detection component 114 may determine a high-voltage isolation fault has occurred when an insulation resistance is outside of an acceptable threshold. For example, if the measured resistance between the high-voltage system 122 and the chassis 124 falls below this threshold, a high-voltage isolation fault may be declared. This threshold may be carefully chosen to balance sensitivity and the avoidance of false positives. Where AC injection methods are used by the monitoring component 112, the IMD may analyze the returned signal for changes in amplitude, frequency, or waveform indicative of a high-voltage isolation fault.

In additional examples of the fault detection component 114, a voltage between different points in the high-voltage system 122 and the chassis 124 may be compared to determine if the difference exceeds an acceptable threshold. In another example, a sudden change in voltage, even not exceeding the absolute threshold, can also trigger an indication that a high-voltage isolation fault has occurred, advantageously helping to detect rapidly developing faults. Those of skill in the art will appreciate additional techniques for monitoring voltages within a vehicle 120, 220, 320 and detecting an anomalous condition after having the benefit of this disclosure, each of which intended to be included within the scope and spirit of this disclosure.

The notification component will now be discussed in greater detail. FIGS. 1-4 highlight examples of the notification component, which may also be shown in other figures. In at least one embodiment, the notification component 116 may, upon detection of a high-voltage isolation fault, operatively engage aspects of the vehicle 120, 220, 320 to alert a user of the detected fault. For example, the notification component 116 may engage an energy management module (EMM) 132 to cause an audiovisual alert 170 to be produced that is observable from outside of the vehicle 120, 220, 320 to warn of precautions required to mitigate risk of receiving an electric shock.

As will be appreciated by those of skill in the art, an EMM 132 may at least partially control power distribution, deciding how to efficiently use and allocate available energy among different systems. An EMM 132 present in electric and hybrid vehicles 120, 220, 320 may assist with controlling high-voltage energy usage, and operation of the EMM may directly impact range and performance of the vehicle 120, 220, 320. The EMM 132 may allocate at least part of the vehicle power to the vehicle equipment to allow the audiovisual alert 170 to be presented to a user.

The notification component 116, upon detection of a fault, may cause the EMM 132 to command a body controller module (BCM) 134 to operate vehicle equipment that is capable of providing the audiovisual alert 170. For example, the notification component 116 may engage the EMM 132 to command a BCM 134 to operate vehicle equipment to produce the audiovisual alert 170 such to bring attention to the vehicle 120, 220, 320.

As will be appreciated by those of skill in the art, the BCM 134 (also known as the body control module or body controller, without limitation) may be provided by computer hardware to monitor and control a wide range of electronic functions within the vehicle 120, 220, 320. For example, the BCM 134 may control lights 150 including headlamps 152, blinkers 154, taillights, interior lights, and turn signals, often including automatic features like daytime running lights and automatic headlight activation. The BCM 134 may additionally control the vehicle's alarm system, wipers, mirrors, sound emitting components 160, horn 162, speakers, locks, and other vehicle features. In various embodiments, one or more of the above example vehicle features and/or other vehicle equipment 140 may be operated to provide the audiovisual alert 170 to an operator, technician, or other user in the event of a detected high-voltage isolation fault, without limitation.

The audiovisual alert will now be discussed in greater detail. FIGS. 1-4 highlight examples of the audiovisual alert, which may also be shown in other figures. The audiovisual alert 170 engaged by the BCM 134 may include a visual alert 180 provided by a light 150 and/or an audio alert 190 provided by a sound emitting component 160, each of which capable of being observed from outside of the vehicle 120, 220, 320. Examples of lights 150 that can be operated for the visual alert include headlamps 152, blinkers 154, and/or other lights that are capable of being noticed outside of the vehicle 120, 220, 320 as would be appreciated by those of skill in the art. Examples of sound emitting components 160 may include a horn 162, beepers, speakers, and/or other sound emitting components capable of being noticed outside of the vehicle 120, 220, 320 as would be appreciated by those of skill in the art. In some embodiments, the lights 150 may be pulsed or flashed, and the horn 162 may be operated in short blips.

In some embodiments, at least part of the audiovisual alert 170 is produced as a pseudorandom display of audiovisual signals to bring attention to detection of the high-voltage isolation fault. In other embodiments, at least part of the audiovisual alert 170 is produced as a coded pattern of audiovisual signals that indicates that the high-voltage isolation fault is detected. Those of skill in the art will appreciate other patterns and displays by which the vehicle equipment 140 may be operated to provide an audiovisual alert 170 that is observable from outside of a vehicle 120, 220, 320 after having the benefit of this disclosure, which are intended to be included within the scope of the present disclosure.

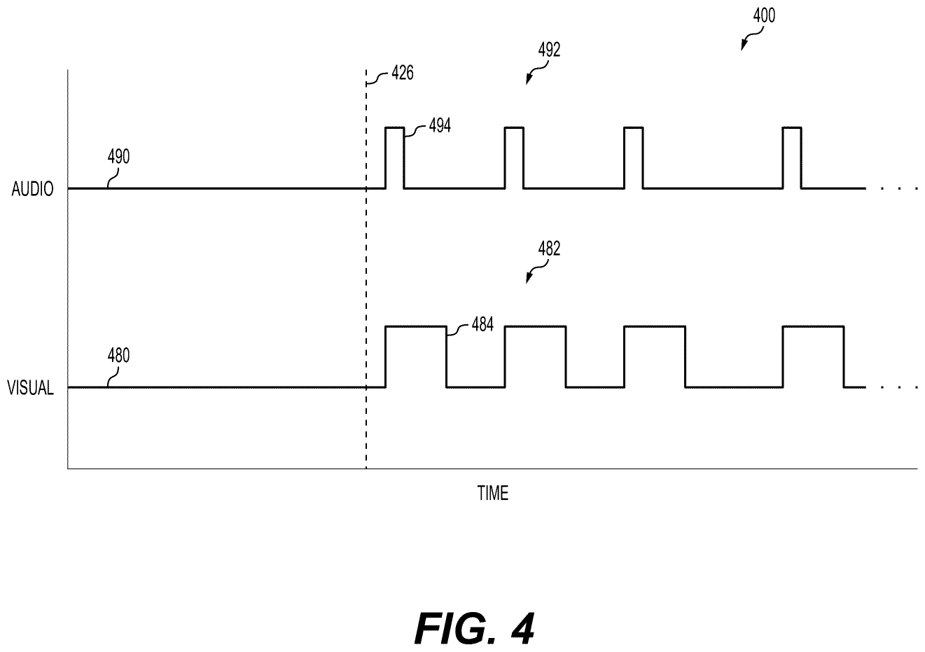

Referring now to graph 400 of FIG. 4, an illustrative audiovisual alert is plotted over time to provide an example of a possible indication presented to a user upon detection of a high-voltage isolation fault, without limitation. As the illustrative operation of graph 400 begins, the monitoring component may monitor a voltage condition of a vehicle. The fault detection component may determine whether the voltage condition is within an acceptable range, which could indicate that no high-voltage isolation fault is detected. This state of no detectable high-voltage isolation fault is indicated by the time prior to event 426.

As the monitoring component continues to observe the voltage condition, the fault detection component may determine that a high-voltage isolation fault has occurred at event 426. Upon determining that a high-voltage isolation fault has occurred at event 426, the fault detection component may signal the notification component to engage aspects of the vehicle to provide an audiovisual alert. The visual output 480 may then enter a visual output alert state 482 and the audio output 490 may enter an audio output alert state 492.

In an example of a detected high-voltage isolation fault, discussed with reference to graph 400, both an audio output 490 and a visual output 480 are plotted over time. Prior to the occurrence of the high-voltage isolation fault event 426, both the visual output 480 and audio output 490 may be essentially disabled. Upon detection of a high-voltage isolation fault at event 426, the visual output 480 may be operated in a visual output alert state 482 and the audio output 490 may be operated in an audio alert state 492. In this example, the visual output alert state 482 and audio output alert state 492 may include audiovisual signals displayed by vehicle equipment in a coded pattern that, when viewed by an operator, technician, or other user, may be used to determine that a high-voltage isolation fault has occurred or is presently occurring.

The visual output 480 operating in the visual output alert state 482 may include multiple emissions of light 484, which may be emitted in a repeating pattern. However, those skilled in the art will appreciate additional embodiments where the visual output 480 is random and/or pseudo-random such as to draw the attention of an operator, technician, or other user.

Similarly, the audio output 490 operating in the audio output alert state 492 may include multiple emissions of sound 494, which may also be emitted in a repeating pattern of blips. For the purpose of this disclosure, blips are intended to be short pulses of sound. However, those skilled in the art will appreciate additional embodiments where the audio output 490 in the audio output alert state 492 is timed to match the visual output 480 operating in the visual output alert state 482, timed independently, or otherwise presented, without limitation. Additionally, those skilled in the art will appreciate that the audio output 490 operating in the audio output alert state 492 may operate in a random and/or pseudo-random pattern to draw attention to the vehicle that a high-voltage isolation fault has occurred or is occurring, without limitation.

Both the visual output 480 and the audio output 490 operating in the alert states 482, 492 are viewable by an operator, technician, or other user external to the vehicle without having to make physical contact with the vehicle to provide a warning to the operator, technician, or other user without putting them in unnecessary harm or danger. In one embodiment, the alert states 482, 492 may continue until disabled by an operator, technician, or other user. Optionally, the visual output 480 and/or audio output 490 may be disabled if the high-voltage isolation fault is no longer detected, which may indicate that the risk of electric shock no longer warrants an alert.

In operation, a method may be provided for notification that is observable outside of a vehicle of a high-voltage isolation fault being detected. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

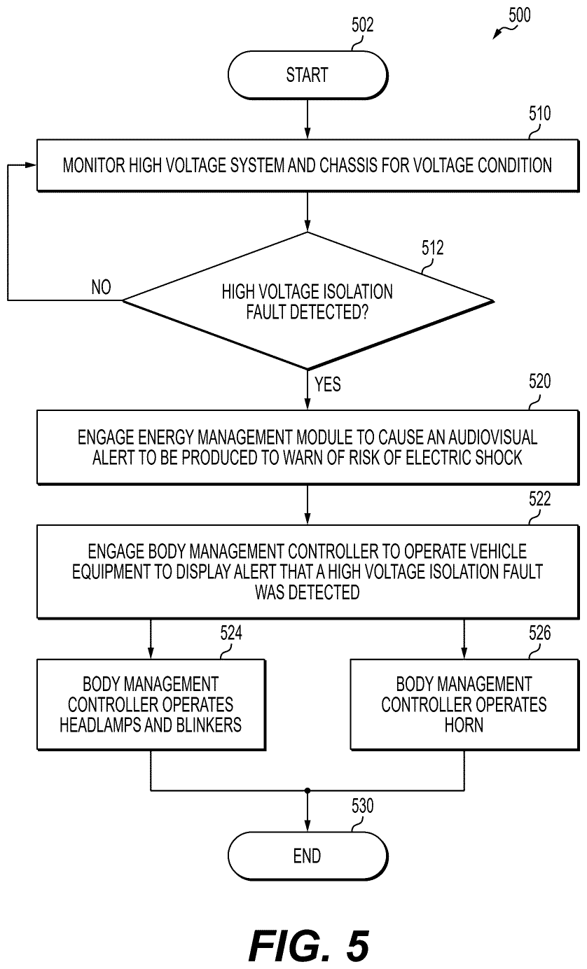

Referring now to flowchart 500 of FIG. 5, an example method for an illustrative operation of providing notification of a detected high-voltage isolation fault will be described, without limitation. Starting with Block 502, the operation may begin by monitoring the high-voltage system and chassis for a voltage condition. (Block 510). It may then be determined at Block 512 whether a high-voltage isolation fault is detected.

If it is determined at Block 512 that no high-voltage isolation fault is detected, the operation may return to Block 510 and continue monitoring the voltage system and chassis for the voltage condition. Conversely, if it is determined at Block 512 that a high-voltage isolation fault is detected, the system may engage the energy management module to cause an audiovisual alert to be produced to warn operators, technicians, and other users of a risk of potential electric shock. (Block 520). The energy management module and/or other systems of a vehicle may engage a body management controller to operate vehicle equipment to display an alert that the high-voltage isolation fault was detected. (Block 522). The alert produced by the vehicle equipment may be observed outside of the vehicle cabin, such as to allow an operator, technician, or other user to be warned of a fault condition without having to make contact with the potentially dangerous vehicle. The body management controller may operate a light such as headlamps and blinkers to provide a visual alert (Block 524). Additionally, the body management controller may operate a sound-emitting device such as a horn to emit an audio alert. (Block 526). The operation may then end at Block 530.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A high-voltage isolation failure notification system for a vehicle comprising:
a monitoring component to monitor a high-voltage system and a chassis for a voltage condition;
a fault detection component to determine whether the voltage condition between the high-voltage system and the chassis is indicative of a high-voltage isolation fault; and
a notification component that, upon detection of a high-voltage isolation fault, operatively engages an energy management module to cause an audiovisual alert to be produced that is observable from outside of the vehicle to warn of precautions required to mitigate risk of receiving an electric shock.

2. The system of claim 1, wherein at least part of the audiovisual alert is produced as a pseudorandom display of audiovisual signals to bring attention to detection of the high-voltage isolation fault.

3. The system of claim 1, wherein at least part of the audiovisual alert is produced as a coded pattern of audiovisual signals that indicates that the high-voltage isolation fault is detected.

4. The system of claim 1, wherein the notification component engages the energy management module to command a body management controller to operate vehicle equipment to produce the audiovisual alert such to bring attention to the vehicle.

5. The system of claim 4, wherein the audiovisual alert comprises a visual alert provided by a light of the vehicle capable of being observed from outside of the vehicle, the light being operated by the body management controller.

6. The system of claim 5, wherein the light comprises headlamps and blinkers being operated by the body management controller.

7. The system of claim 4, wherein the audiovisual alert comprises an audio alert capable of being observed from outside of the vehicle that is provided by a sound emitting component operated by the body management controller.

8. The system of claim 7 wherein the sound emitting component comprises a horn, and wherein producing the audio alert comprises operating the horn in short blips.

9. A system for providing notification of detection of a high-voltage isolation failure for a vehicle comprising:
a monitoring component to monitor a high-voltage system and a chassis for a voltage condition;
a fault detection component to determine whether the voltage condition between the high-voltage system and the chassis is indicative of a high-voltage isolation fault; and
a notification component that, upon detection of a high-voltage isolation fault, operatively engages an energy management module to command a body management controller to operate vehicle equipment to produce an audiovisual alert to warn of a risk of receiving an electric shock;
wherein the vehicle equipment is capable of being observed outside of the vehicle and comprises:
a light, and
a sound emitting component; and
wherein the audiovisual alert comprises:
a visual alert provided by the light, and
an audio alert provided by the sound emitting component.

10. The system of claim 9, wherein at least part of the audiovisual alert is produced as a pseudorandom display of the visual alert and the audio alert to bring the attention to the detection of the high-voltage isolation fault.

11. The system of claim 9, wherein at least part of the audiovisual alert is produced as a coded pattern of the visual alert and the audio alert that indicates that the high-voltage isolation fault is detected.

12. The system of claim 9, wherein the light is emitted by headlamps and blinkers, and wherein the audio alert is emitted by a horn.

13. A method for providing a notification capable of being observed from outside of a vehicle of a high-voltage isolation failure for the vehicle comprising:
a) monitoring a high-voltage system and a chassis for a voltage condition;
b) determining whether the voltage condition between the high-voltage system and the chassis is indicative of a high-voltage isolation fault; and
c) upon detection of a high-voltage isolation fault, engaging an energy management module to notify of a risk of receiving an electric shock;
d) operating vehicle equipment via a body management controller to produce an audiovisual alert that is observable from outside of the vehicle; and
wherein the audiovisual alert comprises:
a visual alert provided by a light of the vehicle, and
an audio alert provided by a sound emitting component of the vehicle.

14. The method of claim 13, wherein step d) further comprises producing at least part of the audiovisual alert as a pseudorandom display of the visual alert and the audio alert to bring the attention to the detection of the high-voltage isolation fault.

15. The method of claim 13, wherein the light comprises headlamps and blinkers, and wherein the sound emitting component comprises a horn.
